(19) United States
(12) Patent Application Publication
(10) Pub. No.: US 2023/0227668 A1
(43) Pub. Date: Jul. 20, 2023

(54) RAPID PROTOTYPING AND DEPLOYMENT OF FLUORESCENT MEDICAL DEVICES

(71) Applicant: Endoglow Prime, LLC, Rochester, NY (US)

(72) Inventor: Jeffrey Augustus Pine, Auburn, NY (US)

(73) Assignee: Endoglow Prime, LLC, Rochester, NY (US)

(21) Appl. No.: 18/156,037

(22) Filed: Jan. 18, 2023

Related U.S. Application Data
(60) Provisional application No. 63/300,467, filed on Jan. 18, 2022.

(51) Int. Cl. C09D 5/22; B33Y 70/00; C09B 67/20; C09B 23/01; C09K 11/06; C09K 11/02; C09D 155/02; C09D 7/41

(52) U.S. Cl. CPC C09D 5/22; B33Y 70/00; C09B 67/0063; C09B 23/0091; C09K 11/06; C09K 11/02; C09D 155/02; C09D 7/41; B29C 64/118

(57) ABSTRACT

Rapid prototyping and delivery of fluorescent medical devices using a 3D printer provided with a processed digital design and fluorescent filament feedstock. The fluorescent filament may comprise a polymer such as acrylonitrile butadiene styrene and between 10 and 100 ppm of a fluorophore such as indocyanine green embedded uniformly throughout the polymer. The filament may include about one percent by weight of a colorant. The 3D printer may be located at the site of use by an end user, such as a physician office, hospital, or operating room for printing of the fluorescent medical device on demand.

### CROSS-REFERENCE TO RELATED APPLICATIONS

The present application claims priority to U.S. Provisional Application No. 63/300,467, filed on Jan. 18, 2022.

### BACKGROUND OF THE INVENTION

### 1. Field of the Invention

The present invention relates to medical devices and, more specifically, to a system and method for providing fluorescent medical devices on demand.

### 2. Description of the Related Art

Various surgical techniques require the use of surgical assist devices such as manipulators, sizers, backers, and the like that help with the identification of anatomical structures and operative tissues by actions such as physically moving, stretching, and relocating tissue at the surgical site. With the growing use of infrared imaging in minimally invasive surgeries, including both straight stick laparoscopic and robotically assisted surgeries, surgical assist devices may also be used to help with visualization of the surgical area, provide form and structure to tissue and related surgical targets, and enable better manipulation of the surgical area. Medical assist devices with embedded fluorescent capabilities can be used to further help visualize the surgical area have been developed as they can provide both physical manipulation of the tissue at the surgical site as well as improved visualization of the tissue via fluorescent imaging, including near-infrared and far-infrared fluorescence. As a result, there is a need for an approach that can allow new devices that take advantage of embedded fluorescence to be quickly and easily designed, prototyped, and delivered to physicians for use in surgical and other practices.

### BRIEF SUMMARY OF THE INVENTION

The present invention provides for rapid prototyping and delivery of finished medical devices. A designer, such as a physician or medical professional, identifies an existing device or new device that can benefit from embedded fluorescence. The design is then transmitted to a remote fabricator for rendering as a three-dimensional digital design file. The digital design is converted into an appropriate set of instructions and setting for use by a 3D printer. The processed digital design may then be manufactured using a 3D printer.

Once completed, the manufactured product may be shipped to the designer for evaluation and/or use. For delivery of finished product, additional product may be printed and shipped to the designer by the fabricator, or the processed digital design may be made available to one or more 3D printers located proximately to the designer or the end user, such as physical office, hospital, or operating room.

Fluorescence is achieved by the use of a specially designed fluorescent filament that is provided along with the processed digital design to the 3D printer that is tasked with printed the final product. The fluorescent filament comprises between about 10 ppm and about 100 ppm of fluorescent dye and up to two percent a colorant like titanium dioxide in polymers such as ABS or PLA.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is a flowchart of a method for rapidly prototyping and producing fluorescent medical devices site according to the present invention;

FIG. 2 is a flowchart of a method for onsite manufacturing of a medical device; and

FIG. 3 is a schematic of an approach for providing fluorescent medical devices via 3D printing from a remote location or on site according to the present invention.

### DETAILED DESCRIPTION OF THE INVENTION

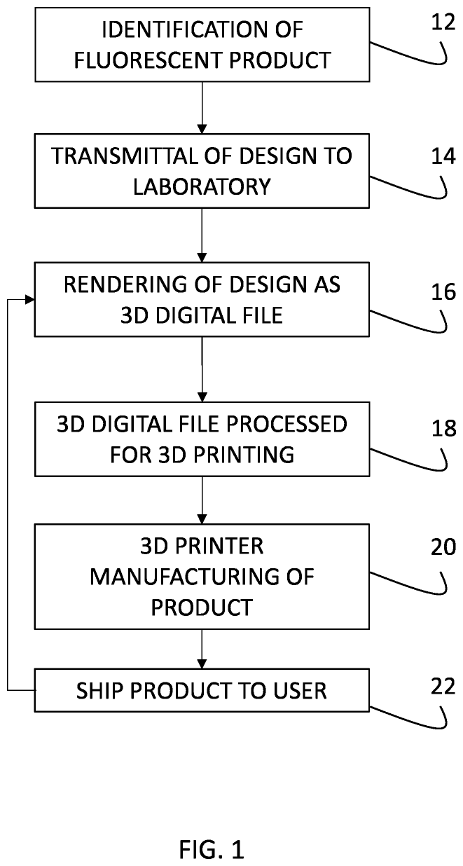

Referring to the figures, wherein like numerals refer to like parts throughout, there is seen in FIG. 1 a method 10 for rapidly prototyping and producing fluorescent medical devices. In a first step, a designer, such as a physician, engineer, or medical professional, identifies an existing device or new device that would benefit from embedded fluorescence 12. Next, the design is transmitted to a remote fabricator for rapid prototyping 14, such as by transmitting images or files over the internet or via electronic communications. Upon receipt of the design at the remote fabricator, the design is rendered in three-dimensions for computer-assisted manufacturing or three-dimensional (3D) printing 16. For example, if the product design is not in an acceptable electronic format, the design may generated in an acceptable three-dimensional format using CAD/CAE software or the like to render the product design as a digital design file that can be further refined and finalized prior to computer-assisted manufacturing or three-dimensional (3D) printing. The digital design may then be processed to convert the digital design into an appropriate set of instructions and setting for use by a 3D printer 18. For example, the digital design is used to determine the extrusion temperature, the extrusion rate/speed, the build plate temperature, and the tool path (movement of the printer to form the shape and internal architecture structure of the device). This process is frequently referred to as slicing and involves the translation of 3D models into instructions that a 3D printer can understand and can be optimized for a particular 3D printer to use for manufacturing. The processed digital design may then be manufactured using a 3D printer 20. One completed, the manufactured product may be shipped to the designer 22 for evaluation and/or use. If the product does not work as intended, the digital design may be further refined by repeating the method from step 16.

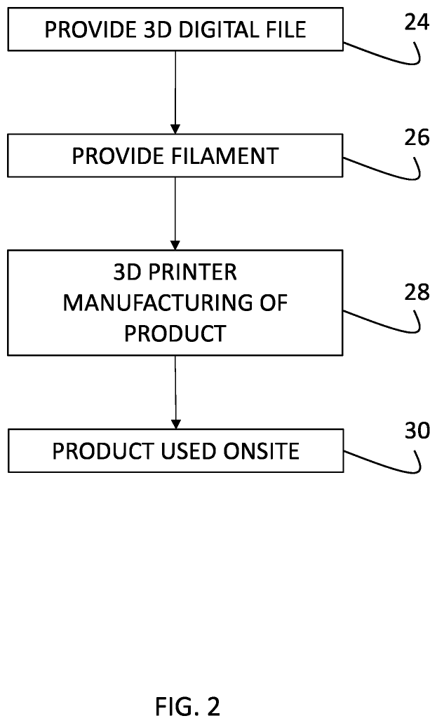

The final product may be printed by fabricator and shipped to the designer or another end user as needed. Alternatively, referring to FIG. 2, the processed digital design file may be provided 24 electronically to one of more 3D printers located proximately to the design or the place of intended use, such as a physical office, hospital, or operating room, for immediate use in procedure. Appropriate filament may also be provided 26 to the place of intended use, and then the product specified in the design file can be manufactured 28. The manufactured product may then be used onsite 30. The present invention thus allows any design to be rapidly prototyped for testing and then produced quickly and inexpensively, thereby making it easier for surgeons and other medical professionals to easily test and develop fluorescent medical devices that can improve patient outcomes. The ability of the present invention to allow for printing of the fluorescent medical device on demand, including at the site of use, has several benefits. For example, hospital inventory footprint and cost can be reduced. Shipping costs are completely avoided, as are indirect expenses such as the carbon cost associated with most transportation. In addition, 3D printing farms outfitted according to the present invention would allow for printing finished goods is low or high volumes. Physicians also have the ability to design and procure devices according to the present invention that are anatomically configured for a specific patient as the present invention allows for rapid manufacturing of a custom printed medical device that fluoresces. For example, in oncologic surgery, anatomy can be distorted such that it is a benefit for the surgeon to have a shape specific medical device for a given patent, thereby allowing for individualized surgical care.

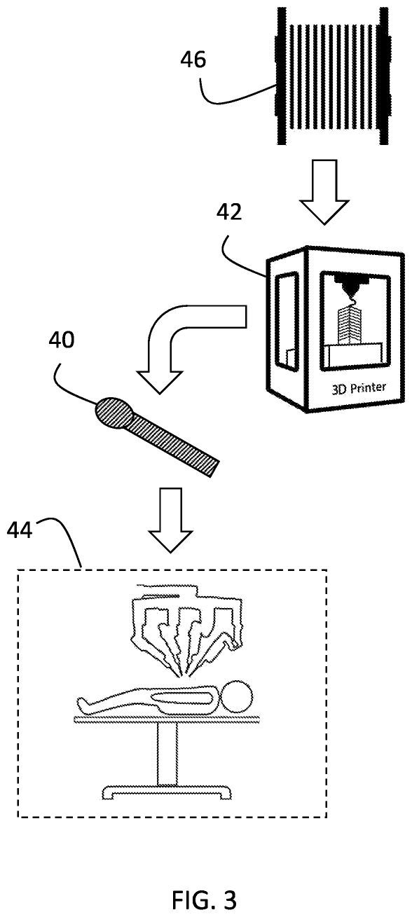

Referring to FIG. 3, the rapid prototyping and manufacturing of a fluorescent medical device 40 via a 3D printer 42 for use in a medical procedure 44, such as a robotic surgery, is possible by use of specially designed fluorescent filament 46 for use with 3D printer 42. Fluorescent filament 46 comprises a polymer suitable for 3D printing that contains a sufficient amount of a fluorophore that will fluoresce in the desired wavelength range in response to excitation from an energy source.

As an example, filament 46 may comprise acrylonitrile butadiene styrene (ABS). It should be recognized that other polymers and copolymers may be suitable, particularly if the final device is to be used for medical purposes. For example, polylactic acid (PLA) may be a suitable polymer due to its biocompatibility and biodegradability. Other suitable polymers may include, without limitation, polypropylene, polystyrene, polycarbonate, polysulfone, polyphenyl sulfone, polymethyl methacrylate, polyethylene, polyamide, polyaryl amide, polyphenyl sulfide, polyether etherketone, polyvinyl chloride, polyethylene terephthalate, and polytetra fluoroethylene. Other polymers, such as urethanes and thermoplastics, and the like may also be used as they are either inert or unlikely to have a significant negative reaction with a subject during the duration of time that a device made from filaments according to the present invention is used with the subject. Filament 36 could also be formed from metal and metal alloys, including constructs capable of fluorescence in the desired spectrum, as well as combination of such metal and alloys with polymers.

If near-infrared fluorescence is desired, filament 36 may include an amount of a near infrared dye such as indocyanine green (ICG) dye. ICG dye for use with the present invention may comprise ICG that is available commercially. For example, Pfaltz & Bauer of Waterbury, Connecticut carries indocyanine green that is acceptable for use with the present invention. The present invention may also use encapsulated ICG dye to achieve superior fluorescence intensity and dye stability against thermal and chemical degradation, and the use of more hydrophobic ICG derivative dyes to reduce fluorescence quenching of ICG in ABS resin. For example, encapsulated ICG dye in layered double hydroxide offer superior dye stability against thermal and chemical degradation. Moreover, the introduction of layered double hydroxide is efficient in improving the mechanical properties and flame retardancy of polymer resins. In addition, layered double hydroxide clay has been demonstrated to be a safe drug carrier and can reduce dye leaching and migration in polymer resins. This option thus presents a solid choice for fluorescent medical devices and is also well suited for both disposable and reusable devices. Other near-infrared dyes that may be used include cyanines having an odd number of carbons in a conjugated polymethine framework, such as pyrrolopyrrole cyanine (PPCy) dyes synthesized via the reaction of diketopyrrolpyrrole with heteroarylacetonitriles, borohydride-reduced cyanines (“hydrocyanines”), iodoacetamide-functionalized cyanines, as well as commercially available dyes such as IR08120 and Epolight 5768.

The proper selection of the fluorescent dye can be important for the desired results. Key parameters in selected the dye include the: (a) emission wavelength and quantum yield; (b) chemical, thermal and photostability of the dye; and (c) compatibility of the dye with the polymer resins including dye polarity (close to the solubility parameter of the polymer matrix), diffusion and migration rates (as low as possible to reduce dye leaching) which depend on the molecular weight, the chemical structure of the dye, and any interactions between the dye and the polymer matrix.

As an example, filament 36 may comprise acrylonitrile butadiene styrene (ABS) with an ICG dye in an amount of 20 ppm to 80 ppm. As too high of a concentration of a fluorophore can result in a quenching, a concentration of 50 ppm may be optimal. It should be recognized that other concentrations may be used depending on the polymer, the particular fluorophore, and the intended use of the product to be made with filament 36. Filament 36 may additionally comprise a colorant to enhance the overall look of the resulting device, and to highlight the fluorescent effect when the device is exposed to an energy source that will trigger fluorescence.

The filament is formed by heating the polymer stock and then thoroughly mixing the requisite amounts of the fluorophore and any colorant. For example, ABS can be mixed with titanium dioxide and ICG to form an ABS, TiO₂, ICG mixture. The mixture may then heated, if necessary, extruded and then cooled using conventional processes for forming 3D printer filament stock in a desired diameter, such as 1.75 mm or 2.85 mm diameter. It should be recognized that any appropriate diameter may be formed for a specific 3D printer, or a custom diameter selected for use in a particular application.

When embedded in a polymer, the fluorescence that results may be insufficient to properly image the surrounding tissue. Accordingly, the present invention may include the enhancement of ICG through the use of organic and inorganic compounds, such as milk, dried milk, tapioca, gelatin, pasta, whey, semolina flour, and Intralipid, that will enhance and modify the amount of distribution of the fluorescence of the ICG embedded device to provide the unexpected benefits of the present invention, such as the enhanced visual depth of field and the ability to easily visualize and determine tissue thicknesses and compositions during a medical procedure. More specifically, organic and inorganic materials may be added to the polymer and ICG mixture to increase the amount of fluorescence and to produce light scatter conditions for optimal fluorescence imaging. With no scattering, excitation energy will pass through the material of the ICG embedded device. With too much scattering, all of the excitation energy is reflected at the surface of ICG embedded device so that images from the fluorescence are oversaturated and impossible to assess. As a result, medical devices according to the present invention may be embedded with optimum quantities of an enhanced dye produce an effective amount of fluorescence based on both the medical application and the particular polymer or material chosen for the medical device.

What is claimed is:

1. A system for producing fluorescent medical devices, comprising a filament having a fluorophore embedded therein, wherein the fluorophore is distributed in the filament at a concentration that will produce fluorescence when the filament is formed into a three-dimensional object and subjected to a wavelength of irradiation corresponding to the fluorophore.

2. The system of claim 1, wherein the filament is formed from a polymer.

3. The system of claim 2, wherein the polymer is selected from the group consisting of acrylonitrile butadiene styrene, polylactic acid, polypropylene, polystyrene, polycarbonate, polysulfone, polyphenyl sulfone, polymethyl methacrylate, polyethylene, polyamide, polyaryl amide, polyphenyl sulfide, polyether etherketone, polyvinyl chloride, polyethylene terephthalate, polytetra fluoroethylene, and combinations thereof.

4. The system of claim 3, wherein the polymer is acrylonitrile butadiene styrene.

5. The system of claim 4, wherein the fluorophore is a dye selected from the group consisting of cyanines, hydrocyanines, and anthraquinones.

6. The system of claim 5, wherein the dye is indocyanine green

7. The system of claim 6, wherein the concentration of the dye in the filament is between 20 ppm and 80 ppm.

8. The system of claim 7, wherein the concentration of the dye in the filament is 50 ppm.

9. The system of claim 1, wherein the filament is formed, at least in part, from a metal.

10. The system of claim 1, wherein the filament is formed, at least in part, from a metal alloy.

11. A method of rapidly producing a medical device, comprising the steps of:
providing a filament having a fluorophore embedded therein, wherein the fluorophore is distributed in the filament at a concentration that will to produce fluorescence when the filament is used to form a three-dimensional object and subjected to a wavelength of irradiation corresponding to the fluorophore; and
printing a three-dimensional object using the filament.

12. The method of claim 11, wherein the filament is formed from a polymer.

13. The method of claim 12, wherein the polymer is selected from the group consisting of acrylonitrile butadiene styrene, polylactic acid, polypropylene, polystyrene, polycarbonate, polysulfone, polyphenyl sulfone, polymethyl methacrylate, polyethylene, polyamide, polyaryl amide, polyphenyl sulfide, polyether etherketone, polyvinyl chloride, polyethylene terephthalate, polytetra fluoroethylene, and combinations thereof.

14. The method of claim 13, wherein the polymer is acrylonitrile butadiene styrene.

15. The method of claim 14, wherein the fluorophore is selected from the group consisting of cyanines, hydrocyanines, and anthraquinones.

16. The method of claim 15, wherein the dye is indocyanine green.

17. The method of claim 16, wherein the concentration of the dye in the filament is between 20 ppm and 80 ppm.

18. The method of claim 17, wherein the concentration of the dye in the filament is 50 ppm.

19. The method of claim 18, wherein the filament is formed, at least in part, from a metal.
